(19) United States
(12) Patent Application Publication
(10) Pub. No.: US 2016/0010534 A1
(43) Pub. Date: Jan. 14, 2016

(54) COMPLEX HEAT EXCHANGER

(71) Applicant: CALSONIC KANSEI CORPORATION, Saitama-shi, Saitama (JP)

(72) Inventors: Hironobu KAWAKAMI, Saitama-shi, Saitama (JP); Eiichi MORI, Saitama-shi, Saitama (JP); Naoya TSUJIMOTO, Saitama-shi, Saitama (JP)

(21) Appl. No.: 14/773,247

(22) PCT Filed: Jan. 27, 2014
(86) PCT No.: PCT/JP2014/051652

§ 371 Date: Sep. 4, 2015

(30) Foreign Application Priority Data
Mar. 6, 2013 (JP) 2013-043894
Mar. 6, 2013 (JP) 2013-043895

(51) Int. Cl. F01P 3/18; F01P 11/00; B60H 1/00; F01P 9/06

(52) U.S. Cl. CPC F01P 3/18; F01P 9/06; F01P 11/00; B60H 1/00328; B60H 1/00342; F01P 2003/182; F01P 2003/185

(57) ABSTRACT

A complex heat exchanger (1) according to the present invention includes a sub radiator (20) for cooling water-cooling cooling water passing through heavy current device (3), an air-cooled condenser (40) for cooling a air-conditioning refrigerant different from the water-cooling cooling water, and a water-cooled condenser (30) for performing heat exchange between the water-cooling cooling water and the air-conditioning refrigerant. The water-cooling cooling water flows into the sub radiator (20) after passing through the water-cooled condenser (30) and is cooled and then, the water-cooling cooling water is used for cooling of the heavy current device (3). The air-conditioning refrigerant cooled by the water-cooled condenser (30) flows into the air-cooled condenser (40).

### TECHNICAL FIELD

The present invention relates to a complex heat exchanger mounted on an automobile.

### BACKGROUND ART

Conventionally, complex heat exchangers mounted on an automobile includes a complex heat exchanger provided with a main radiator which cools cooling water for an engine, a sub radiator which cools water-cooling cooling water for a heavy current device (a power driving source, on-board electric device such as an inverter or the like), a water-cooled condenser for performing heat exchange between the water-cooling cooling water flowing out of the sub radiator and an air-conditioning refrigerant, and an air-cooled condenser for cooling the air-conditioning refrigerant flowing out of the water-cooled condenser (see Patent Literature 1, for example).

An example of the water-cooled condenser used in this type of the complex heat exchanger will be described by referring to FIG. 17. As illustrated in FIG. 17, the air-conditioning refrigerant before flowing into the air-cooled condenser 130 is cooled by the water-cooled condenser 110. In order to cool the air-conditioning refrigerant by using the water-cooling cooling water subjected to heat exchange in the sub radiator 120, the water-cooled condenser 110 is provided on a side of an outflow-side tank of the sub radiator 120.

Specifically, the water-cooling cooling water cooled by the sub radiator 120 is configured to perform heat exchange with the air-conditioning refrigerant before flowing into the air-cooled condenser 130 and then, to flow into the heavy current device 140. On the other hand, the air-conditioning refrigerant circulating in the refrigerating cycle first flows into the water-cooled condenser 110 from a compressor and then, flows out to the air-cooled condenser 130. As a result, the air-conditioning refrigerant until it flows into the air-cooled condenser 130 can be efficiently cooled.

### CITATION LIST

### Patent Literature

Patent Literature 1: Japanese Patent Laid-Open Publication No. 2010-127508

### SUMMARY OF INVENTION

### Technical Problem

However, in the above-described prior-art complex heat exchanger 100, though the water-cooling cooling water having been cooled by passing through the sub radiator 120 can cool the high-temperature and high-pressure air-conditioning refrigerant before flowing into the air-cooled condenser 130, the water-cooling cooling water is subjected to heat exchange with this air-conditioning refrigerant and its temperature rises. Thus, the water-cooling cooling water whose temperature has risen flows into the heavy current device 140, and there is a concern that the heavy current device cannot be cooled efficiently.

Thus, the present invention was made in order to solve the above-described problem and has an object to provide a complex heat exchanger capable of efficiently cooling the heavy current device while cooling the air-conditioning refrigerant before flowing into the air-cooled condenser.

### Solution to Problem

A complex heat exchanger of the present invention is a complex heat exchanger including a first heat exchanger for cooling a first refrigerant, a second heat exchanger for cooling a second refrigerant different from the first refrigerant, and a third heat exchanger for performing heat exchange of the first refrigerant and the second refrigerant, in which the first refrigerant is subjected to heat exchange with the second refrigerant while passing through the third heat exchanger, the first refrigerant subjected to heat exchange in the third heat exchanger is cooled while passing through the first heat exchanger, the first refrigerant cooled by the first heat exchanger is used for cooling of the heavy current device, and the second refrigerant subjected to heat exchange in the third heat exchanger passes through the second heat exchanger.

In the complex heat exchanger of the present invention, it is preferable that the second heat exchanger is arranged on an upper side or a lower side of the first heat exchanger, and the first refrigerant passing through the first heat exchanger flows in the same direction as that of the second refrigerant passing through the second heat exchanger.

In the complex heat exchanger of the present invention, it is preferable that the first heat exchanger has a first heat exchange portion and a second heat exchange portion provided on the upper side or the lower side of the first heat exchange portion, and the first refrigerant passes through the second heat exchange portion via the third heat exchanger after passing through the first heat exchange portion.

In the complex heat exchanger of the present invention, it is preferable that the second heat exchanger is arranged adjacent to the second heat exchange portion, and the first refrigerant passing through the second heat exchange portion flows in the same direction as that of the second refrigerant passing through the second heat exchanger.

In the complex heat exchanger of the present invention, it is preferable that the second heat exchange portion is arranged adjacent to the first heat exchange portion, and the second heat exchange portion is arranged at a position away from the second heat exchanger while sandwiching the first heat exchange portion.

In the complex heat exchanger of the present invention, it is preferable that the first heat exchanger is provided with a first right-side tank provided on one side of the first heat exchanger and a side where the first refrigerant flows out and a first left-side tank provided on the other side of the first heat exchanger.

In the complex heat exchanger of the present invention, the third heat exchanger is preferably provided in the first left-side tank.

In the complex heat exchanger of the present invention, it is preferable that a fourth heat exchanger provided on the downstream side of a cooling water passing through the first heat exchanger and the second heat exchanger is further provided, on a fourth inflow-side tank of the fourth heat exchanger, the first left-side tank and a second inflow/outflow tank of the second heat exchanger are fixed close to each other, and on a fourth outflow-side tank of the fourth heat exchanger, the first right-side tank and a tank for a second turn of the second heat exchanger are fixed close to each other.

In the complex heat exchanger of the present invention, it is preferable that the fourth heat exchanger provided on the downstream side of the cooling air passing through the first heat exchanger and the second heat exchanger is further provided.

In the complex heat exchanger of the present invention, it is preferable that the first heat exchanger and the second heat exchanger have fixing portions, respectively, and the fourth heat exchanger has a fixed portion to which the fixing portions are fixed, respectively.

In the complex heat exchanger of the present invention, it is preferable that a refrigerant inlet of the first heat exchanger, a refrigerant inlet of the second heat exchanger, and a refrigerant inlet of the fourth heat exchanger are arranged on the same side with respect to a core portion of the fourth heat exchanger.

### BRIEF DESCRIPTION OF DRAWINGS

FIG. 1 is an entire perspective view illustrating a complex heat exchanger according to a first embodiment.

FIG. 2 is a front view illustrating the complex heat exchanger according to the first embodiment.

FIG. 3 is a configuration view illustrating a heat exchange system to which the complex heat exchanger according to the first embodiment is applied.

FIG. 4 is an exploded perspective view illustrating an inflow-side tank (first left-side tank) of a sub radiator and a water-cooled condenser according to the first embodiment.

FIG. 5 is an enlarged exploded perspective view illustrating a water-cooled condenser according to the first embodiment.

FIG. 6 is a sectional view illustrating the vicinity of the inflow-side tank (first left-side tank) of the sub radiator and a refrigerant inflow portion of the water-cooled condenser according to the first embodiment.

FIG. 7(a) is a schematic view illustrating flows of water-cooling cooling water and an air-conditioning refrigerant of a complex heat exchanger according to a comparative example, and FIG. 7(b) is a schematic view illustrating temperatures of the water-cooling cooling water and the air-conditioning refrigerant of the complex heat exchanger according to the comparative example.

FIG. 8(a) is a schematic view illustrating flows of water-cooling cooling water and an air-conditioning refrigerant of the complex heat exchanger according to the first embodiment, and FIG. 8(b) is a schematic view illustrating temperatures of the water-cooling cooling water and the air-conditioning refrigerant of the complex heat exchanger according to the first embodiment.

FIG. 9(a) is a graph illustrating a temperature situation of the water-cooling cooling water of the complex heat exchanger according to the comparative example, and FIG. 9(b) is a graph illustrating the temperature situation of the water-cooling cooling water of the complex heat exchanger according to the first embodiment.

FIG. 10 is an entire perspective view illustrating a complex heat exchanger according to a second embodiment.

FIG. 11 is a front view illustrating the complex heat exchanger according to the second embodiment.

FIG. 12 is a configuration view illustrating a heat exchange system to which the complex heat exchanger according to the second embodiment is applied.

FIG. 13 is a schematic view illustrating flows of water-cooling cooling water and an air-conditioning refrigerant of the complex heat exchanger according to the second embodiment.

FIG. 14 is a graph illustrating a temperature situation of the water-cooling cooling water of the complex heat exchanger according to the second embodiment.

FIG. 15 is a schematic view of the complex heat exchanger according to the second embodiment when seen from a plane (upper surface).

FIG. 16 is a schematic view illustrating flows of the water-cooling cooling water and the air-conditioning refrigerant of the complex heat exchanger according to a variation of the second embodiment.

FIG. 17 is a configuration view illustrating a part of a heat exchange system to which a complex heat exchanger according to the Background Art is applied.

### DESCRIPTION OF EMBODIMENTS

Embodiments of the present invention will be described below on the basis of the attached drawings. In the description of the drawings below, the same or similar reference numerals are given to the same or similar portions. However, the drawings are schematic and it should be noted that ratios of dimensions are different from actual ones. Therefore, specific dimensions should be determined by considering the description below. Moreover, portions with relations or ratios of dimensions different among the drawings can be included.

### First Embodiment

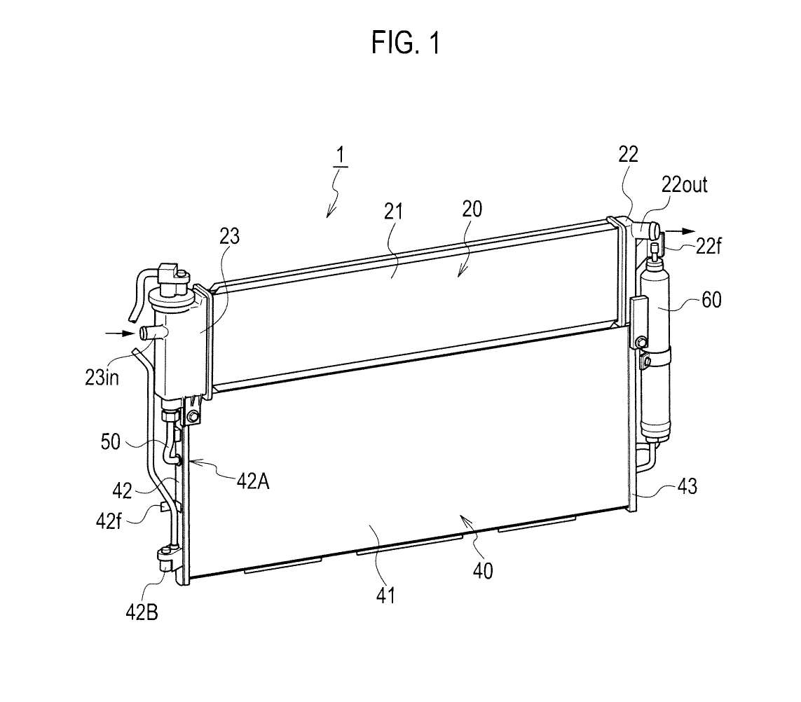

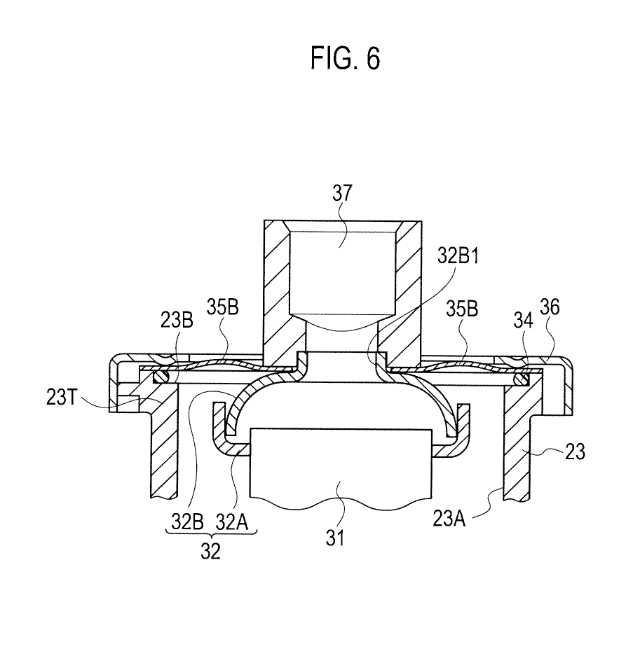

A complex heat exchanger 1 according to a first embodiment will be described by using FIGS. 1 to 9.

### (Configuration of Complex Heat Exchanger)

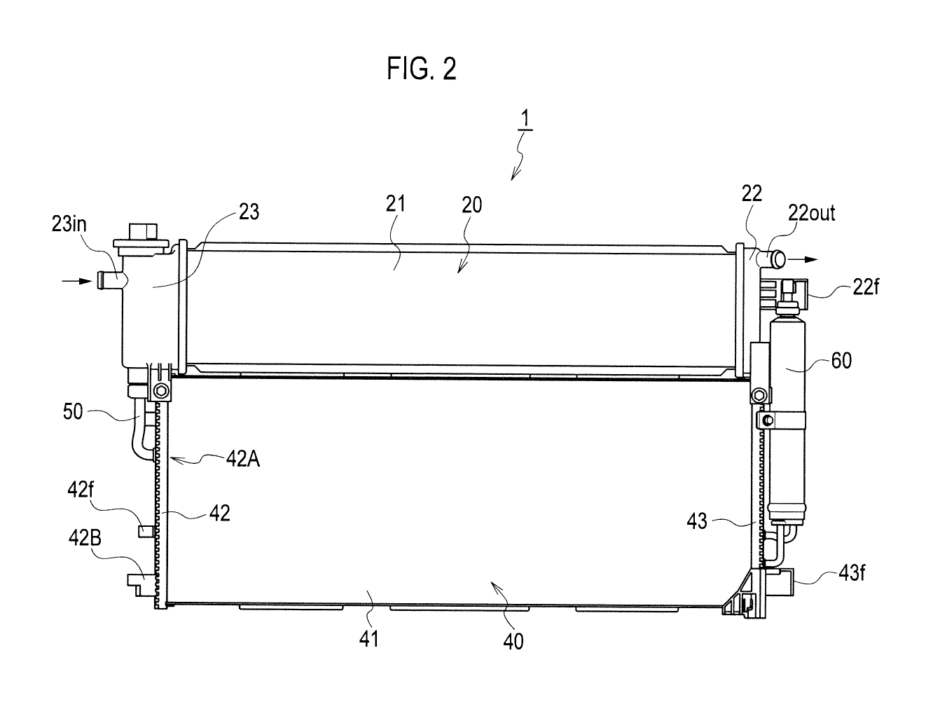

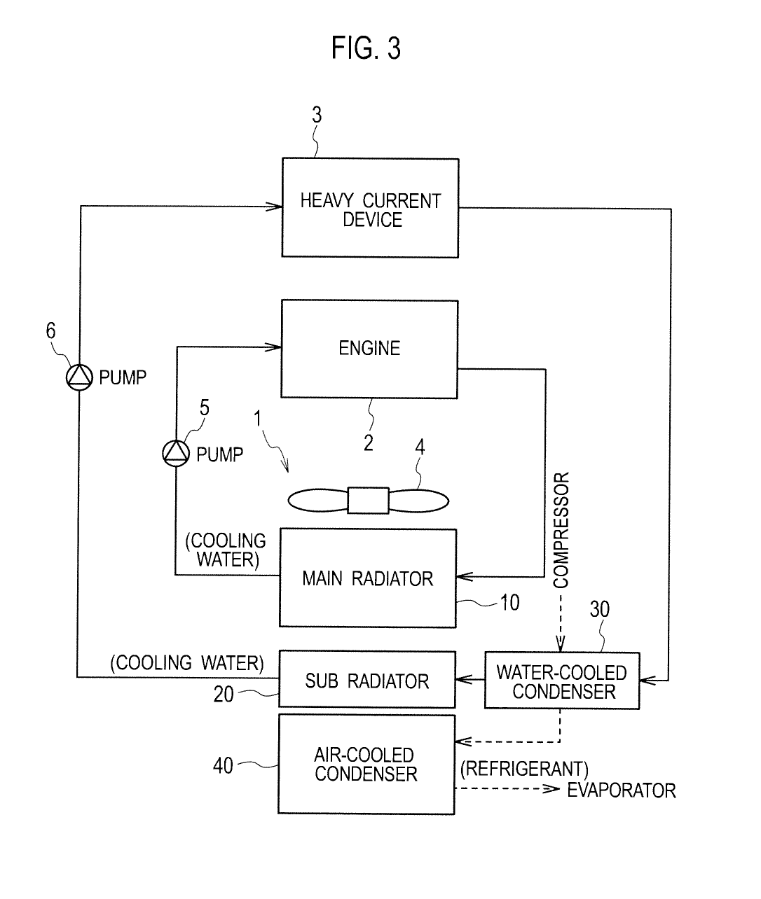

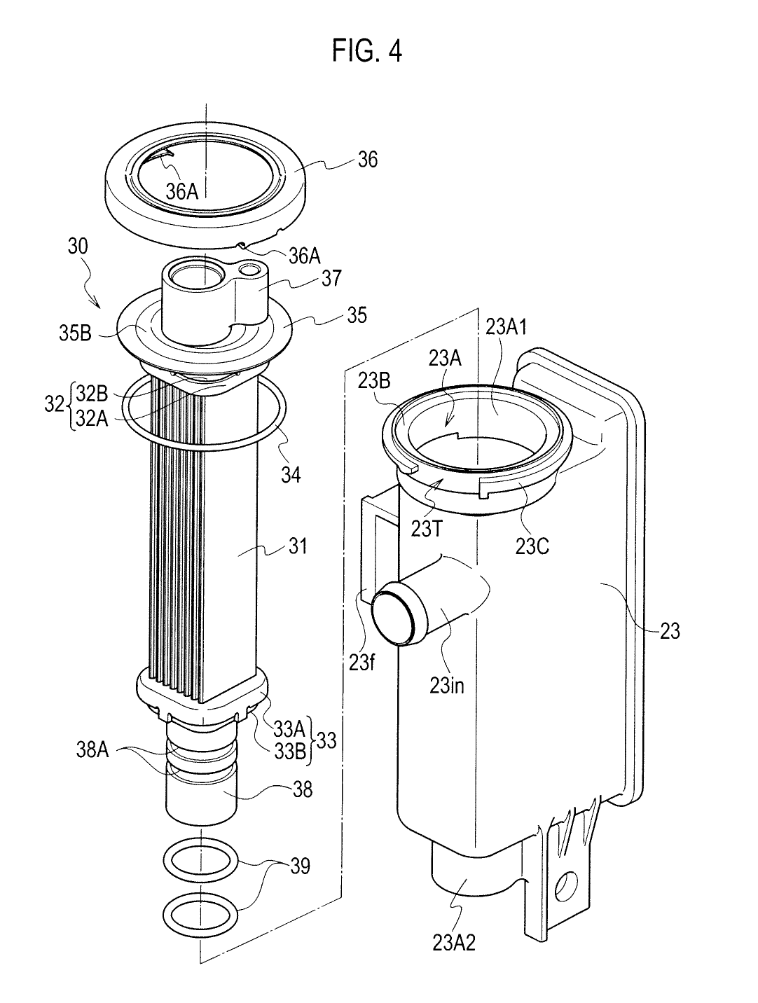

First, a configuration of the complex heat exchanger 1 according to this embodiment will be described by referring to the attached drawings. FIG. 1 is an entire perspective view illustrating the complex heat exchanger 1 according to this embodiment. FIG. 2 is a front view illustrating the complex heat exchanger 1 according to this embodiment. FIG. 3 is a configuration view illustrating a heat exchange system to which the complex heat exchanger 1 according to this embodiment is applied. FIGS. 4 to 6 are views illustrating the vicinity of an inflow-side tank 23 (first left-side tank) of a sub radiator 20 according to this embodiment. The complex heat exchanger 1 is assumed to be used in a hybrid electric vehicle (HEV) on which an electric driving source or other electric devices, that is, heavy current device as on-board device such as an inverter or the like are mounted in addition to an engine.

The complex heat exchanger 1 includes a main radiator 10 as a fourth heat exchanger (see FIG. 3), a sub radiator 20 as a first heat exchanger, a water-cooled condenser 30 as a third heat exchanger, and an air-cooled condenser 40 as a second heat exchanger. In the complex heat exchanger 1, heat exchange is performed between the water-cooling cooling water as a first refrigerant for cooling heavy current device 3 such as a power driving source or on-board electric device such as an inverter or the like and the air-conditioning refrigerant as a second refrigerant for cooling an evaporator which is different from the water-cooling cooling water, the heat-exchanged water-cooling cooling water is made to flow into the sub radiator 20, and the heat-exchanged air-conditioning refrigerant is made to flow into the air-cooled condenser 40.

Specifically, the main radiator 10 is to cool cooling water for an engine of the engine 2 circulated by a pump 5 as illustrated in FIG. 3. The main radiator 10 is provided on a downstream side of cooling air passing through the sub radiator 20 and the air-cooled condenser 40 and on an upstream side of cooling air of a motor fan 4. The main radiator 10 includes a plurality of radiator tubes 11, not shown, through which the cooling water for an engine passes and performing heat exchange with the cooling air flowing outside thereof, a radiator tank (hereinafter referred to as an inflow-side tank 12 (fourth inflow-side tank), not shown, and an outflow-side tank 13 (fourth outflow-side tank), not shown) to which both side ends of the plurality of the radiator tubes 11 are connected, respectively. A width of the main radiator 10 as above is substantially equal to widths of the sub radiator 20 and the air-cooled condenser 40.

The sub radiator 20 is for cooling the water-cooling cooling water for the heavy current device 3 (a power driving source, on-board electric device such as an inverter or the like) circulated by the pump 6. The sub radiator 20 does not necessarily have to be the heavy current device 3 such as the power driving source, the on-board electric device such as an inverter or the like but may cool the refrigerant used in a water-cooling charge air cooler (water-cooling CAC), for example.

The sub radiator 20 is arranged on an upstream surface side of the cooling air of the main radiator 10 and also in an upper region as illustrated in FIGS. 1 to 3. The sub radiator 20 includes a plurality of sub radiator tubes 21 through which the water-cooling cooling water passes and performing heat exchange with the cooling air flowing outside thereof, a sub radiator tank (hereinafter referred to as an outflow-side tank 22 (first right-side tank) and an inflow-side tank 23 (first left-side tank)) to which the both side ends of the plurality of the sub radiator tubes 21 are connected, respectively.

The outflow-side tank 22 is provided on one side of the sub radiator 20 and on the side where the water-cooling cooling water flows out, and the inflow-side tank 23 is provided on the other side of the sub radiator 20.

In a state in which the sub radiator 20 is arranged with respect to the main radiator 10, the inflow-side tank 23 of the sub radiator 20 and an inflow/outflow tank 42 of the air-cooled condenser 40 are arranged close to the inflow-side tank 12 side of the main radiator 10. Moreover, the outflow-side tank 22 of the sub radiator 20 and a liquid-side tank 43 of the air-cooled condenser 40 are arranged close to the outflow-side tank 13 side of the main radiator 10.

On each of the inflow-side tank 23 and the outflow-side tank 22, fixing claws 23f and 22f each having a substantially L-shape are provided as fixing portions. In the inflow-side tank 23, an inflow portion 23in (refrigerant inlet) into which the water-cooling cooling water flows is formed. On the other hand, the outflow-side tank 22 has an outflow portion 22out from which the water-cooling cooling water flows out is formed.

In the inflow-side tank 23, as illustrated in FIG. 4, an accommodating chamber 23A having a rectangular section in which the water-cooled condenser 30 is accommodated is provided. In this embodiment, the accommodating chamber 23A is described by having a rectangular sectional shape, but this is not limiting, and it may be circular, for example, and the shape can be arbitrarily set.

On an upper side of the accommodating chamber 23A, an upper insertion opening portion 23A1 into which the water-cooled condenser 30 is inserted is provided. As illustrated in FIGS. 4 to 6, a stepped portion 23B on which an O-ring 34 which will be described later of the water-cooled condenser 30 is arranged is formed on a peripheral edge of the upper insertion opening portion 23A1. Moreover, in the periphery of the upper insertion opening portion 23A1, a mounting portion 23T on which a cap 36 which will be described later of the water-cooled condenser 30 is mounted is provided. On this mounting portion 23T, a guide portion 23C for guiding rotation of the cap 36 which will be described later of the water-cooled condenser 30 to a lock position is provided.

On a lower side of the accommodating chamber 23A, a lower support opening portion 23A2 formed at a position opposed to the upper insertion opening portion 23A1 is provided. The lower support opening portion 23A2 is formed by a cylindrical tube portion and a refrigerant outflow portion 38 which will be described later of the water-cooled condenser 30 is inserted.

The water-cooled condenser 30 is for performing heat exchange between the water-cooling cooling water before flowing into the sub radiator 20 and the air-conditioning refrigerant before flowing into the air-cooled condenser 40. The water-cooled condenser 30 is, as illustrated in FIG. 4, accommodated in the outflow-side tank 22 of the sub radiator 20, and this water-cooled condenser 30 and the air-cooled condenser 40 are serially connected into the refrigerating cycle with the water-cooled condenser 30 as an upstream. Details of the water-cooled condenser 30 will be described later.

The air-cooled condenser 40 is for cooling the air-conditioning refrigerant flowing out of the water-cooled condenser 30. The air-cooled condenser 40 is arranged on the upstream surface side of the cooling air of the main radiator 10 and on the lower region of the sub radiator 20 as illustrated in FIGS. 1 to 3. The air-cooled condenser 40 is arranged on substantially the same plane as the sub radiator 20 along the direction orthogonal to the flow of the cooling air. The air-cooled condenser 40 includes an air-cooled tube 41 through which the air-conditioning refrigerant passes and performs heat exchange with the cooling air flowing outside thereof, an air-cooled tank (hereinafter referred to as the inflow/outflow tank 42 (second inflow/outflow tank) and the liquid-side tank 43 (tank for second turn)) to which both ends of the air-cooled tube 41 are connected, respectively.

On the inflow/outflow tank 42 and the liquid-side tank 43, fixing claws 42f and 43f each having a substantially L-shape as a fixing portion are provided.

On the inflow/outflow tank 42, an inflow portion 42A (refrigerant inlet) through which the air-conditioning refrigerant before heat exchange in the air-cooled condenser 40 flows in and an outflow portion 42B through which the air-conditioning refrigerant after heat exchange in the air-cooled condenser 40 flows out are formed.

The inflow portion 42A and the outflow portion 42B are provided at positions spaced away with respect to the longitudinal direction of the inflow-outflow tank 42. To the inflow portion 42A, a relay pipeline 50 communicating with the inflow/outflow tank 42 is connected (see FIGS. 1 to 2). One end of the relay pipeline 50 is connected to the refrigerant outflow portion 38 which will be described later of the water-cooled condenser 30, while the other end of the relay pipeline 50 is made to communicate with the inflow/outflow tank 42.

On a side portion of the liquid-side tank 43, a liquid tank 60 for gas/liquid separation of the air-conditioning refrigerant is provided (FIGS. 1 and 2). The liquid refrigerant (air-conditioning refrigerant) flowing out of this liquid tank 60 passes through a lower region of the air-cooled tube 41 and flows out of the outflow portion 42B.

### (Configuration of Water-Cooled Condenser)

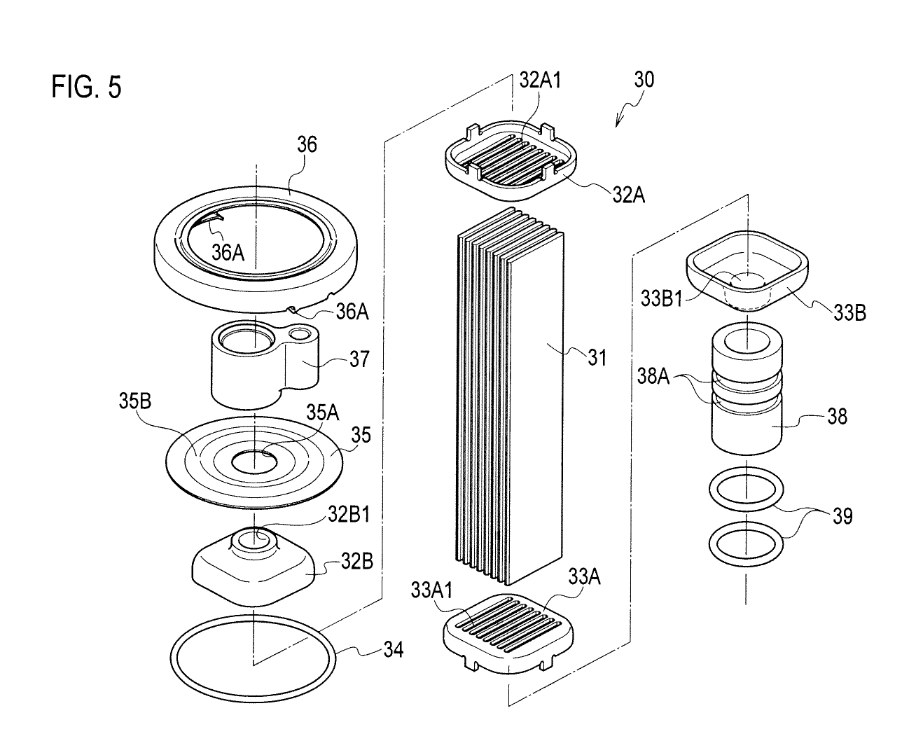

Subsequently, a configuration of the above-described water-cooled condenser 30 will be described by referring to FIGS. 4 and 5.

As illustrated in FIGS. 4 and 5, the water-cooled condenser 30 inserted from the upper insertion opening portion 23A1 is fixed to the inflow-side tank 23 at two positions, that is, a position of the upper insertion opening portion 23A1 and a position of the lower support opening portion 23A2 different from the upper insertion opening portion 23A1.

Specifically, the water-cooled condenser 30 includes a plurality of water-cooled tubes 31, a pair of water-cooled tanks 32 and 33, an O-ring 34, a disc-shaped sealing plate 35, a cap 36, a pair of refrigerant inflow portion 37 and refrigerant outflow portion 38, and two shaft seals 39.

Each of the water-cooled tubes 31 performs heat exchange between the air-conditioning refrigerant passing therethrough and the water-cooling cooling water passing through the inflow-side tank 23 on the outside thereof. Each of the water-cooled tubes 31 is provided between the pair of water-cooled tanks 32 and 33. Each of the water-cooled tubes 31 is formed by extrusion molding.

To each of the water-cooled tanks 32 and 33, both ends of each of the water-cooled tubes 31 are connected, respectively. Each of the water-cooled tanks 32 and 33 is constituted by inner plates 32A and 33A in which fitting holes 32A1 and 33A1 with which both ends of each of the water-cooled tubes 31 are fitted are formed and outer plates 32B and 33B in which refrigerant passage portions 32B1 and 33B1 attached to each of the inner plates 32A and 33A and through which the air-conditioning refrigerant can pass are formed.

The O-ring 34 is arranged on the stepped portion 23B (see FIGS. 4 to 6) formed on an upper surface of the inflow-side tank 23. On the upper side of this O-ring 34, the sealing plate 35 is arranged.

The sealing plate 35 prevents outflow of the water-cooling cooling water passing through the inflow-side tank 23 by abutting against the upper side of the O-ring 34 and a peripheral edge of the upper insertion opening portion 23A1 of the inflow-side tank 23 and closing the upper insertion opening portion 23A1. In the sealing plate 35, a refrigerant passage hole 35A fixed to the refrigerant inflows portion 37 and through which the air-conditioning refrigerant passes and a bead portion 35B protruding toward the cap 36 side and along a circumferential direction are provided. The cap 36 is attached to the upper surface of the inflow-side tank 23 by pressing such sealing plate 35 toward the O-ring 34.

The cap 36 has a claw portion 36A rotated along the guide portion 23C (see FIGS. 4 and 5) formed on an outer peripheral surface of an upper part of the inflow-side tank 23 and locked at a lock position. The cap 36 fixes the water-cooled condenser 30 to the inflow-side tank 23 by being attached to the inflow-side tank 23.

The refrigerant inflow portion 37 and the refrigerant outflow portion 38 are fixed to the water-cooled tanks 32 and 33, respectively, and are provided at positions opposed to each other (upper surface and lower surface) of the inflow-side tank 23.

Specifically, the refrigerant inflow portion 37 is an inlet through which the air-conditioning refrigerant flows into the water-cooled condenser 30 and is fixed to the outer plate 32B (peripheral surface of the refrigerant passage portion 32B1) on the upper side by sandwiching the sealing plate 35. One side (upper side) of the water-cooled condenser 30 on which this refrigerant inflow portion 37 and the above-described water-cooled tank 32 are provided is fixed at a position of the upper insertion opening portion 23A1. In this fixed state, the refrigerant inflow portion 37 is exposed to the outside of the upper insertion opening portion 23A1.

On the other hand, the refrigerant outflow portion 38 is an outlet through which the air-conditioning refrigerant flows out to the water-cooled condenser 30 and is fixed to the lower outer plate 33B (peripheral surface of the refrigerant passage portion 33B1). The refrigerant outflow portion 38 is formed by a cylindrical tube portion and is arranged on an inner periphery of the cylindrical lower support opening portion 23A2 in the inflow-side tank 23 of the sub radiator 20. The other side (lower side) of the water-cooled condenser 30 on which this refrigerant outflow portion 38 and the above-described water-cooled tank 33 are provided is fixed at a position of the lower support opening portion 23A2 different from the upper insertion opening portion 23A1. In this fixed state, the refrigerant outflow portion 38 is exposed to the outside of the lower support opening portion 23A2. This exposed refrigerant outflow portion 38 is connected to the inflow/outflow tank 42 through the relay pipeline 50.

On an outer periphery of this refrigerant outflow portion 38, a shaft seal groove 38A into which the shaft seal 39 is inserted is formed. The refrigerant outflow portion 38 is inserted into the lower support opening portion 23A2 and supported thereon.

The shaft seal 39 is interposed between the outer periphery of the refrigerant outflow portion 38 and the inner periphery of the lower support opening portion 23A2 by being inserted into the shaft seal groove 38A of the refrigerant outflow portion 38 in a state in which the refrigerant outflow portion 38 penetrates through the lower support opening portion 23A2.

### (Flow of Refrigerant)

Subsequently, a flow of each refrigerant in the above-described complex heat exchanger 1 will be described by referring to FIG. 3.

As illustrated in FIG. 3, the water-cooling cooling water for cooling the heavy current device 3 is cooled by the sub radiator 20. The water-cooling cooling water cooled by this sub radiator 20 passes through the heavy current device 3 and then, passes through the water-cooled condenser 30, flows into the sub radiator 20 and is cooled therein.

On the other hand, the air-conditioning refrigerant raised to a high temperature and a high pressure by a compressor 8 of the refrigerating cycle first flows into the water-cooled condenser 30 and is subjected to heat exchange with the water-cooling cooling water and is cooled. Then, the air-conditioning refrigerant cooled by the water-cooled condenser 30 flows into the air-cooled condenser 40 and is subjected to heat exchange in the air-cooled condenser 40 and then, flows out to the evaporator.

### (Comparative Evaluation)

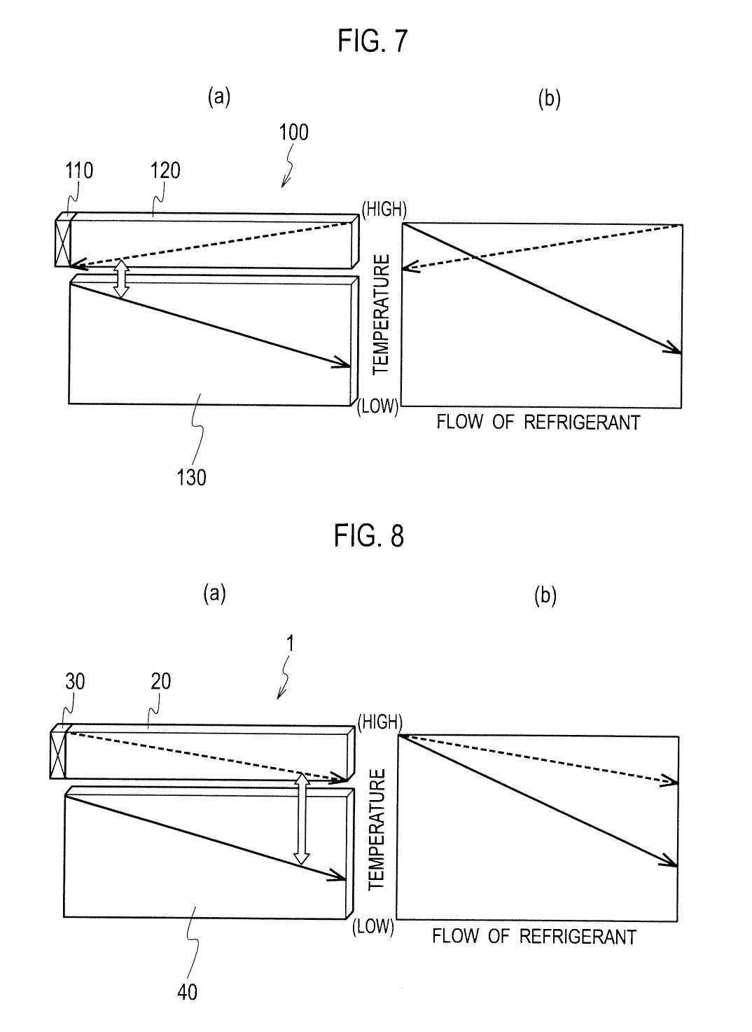

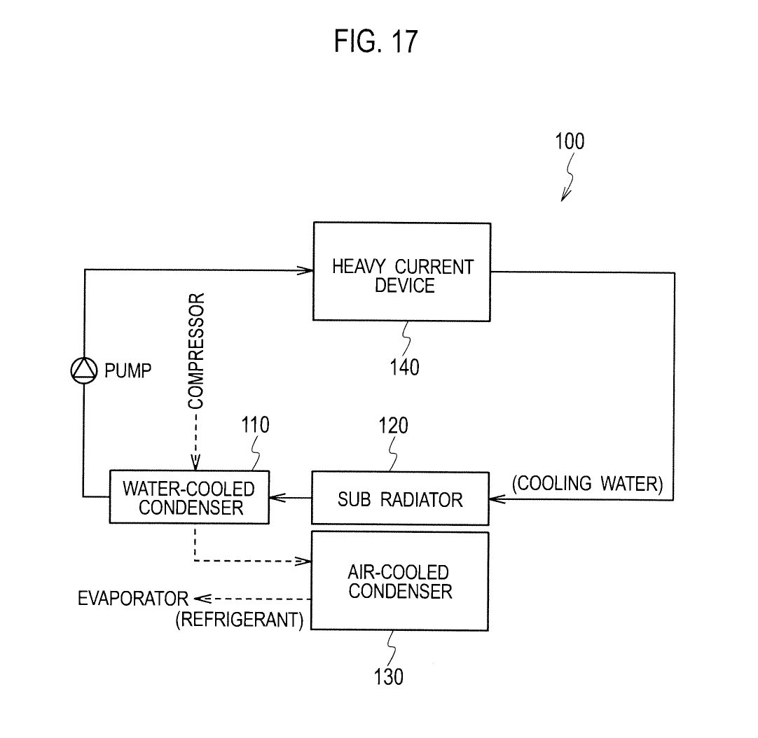

Subsequently, a comparative evaluation between the complex heat exchanger 100 as a comparative example illustrated in FIG. 17 and the complex heat exchanger 1 of the above-described embodiment will be described by referring to FIGS. 7 to 9. FIG. 7(a) is a schematic view illustrating flows of the water-cooling cooling water and the air-conditioning refrigerant of the complex heat exchanger 100 according to the comparative example, and FIG. 7(b) is a schematic view illustrating temperatures of the water-cooling cooling water and the air-conditioning refrigerant of the complex heat exchanger 100 according to the comparative example. FIG. 8(a) is a schematic view illustrating flows of the water-cooling cooling water and the air-conditioning refrigerant of the complex heat exchanger 1 according to this embodiment, and FIG. 8(b) is a schematic view illustrating temperatures of the water-cooling cooling water and the air-conditioning refrigerant of the complex heat exchanger 1 according to this embodiment.

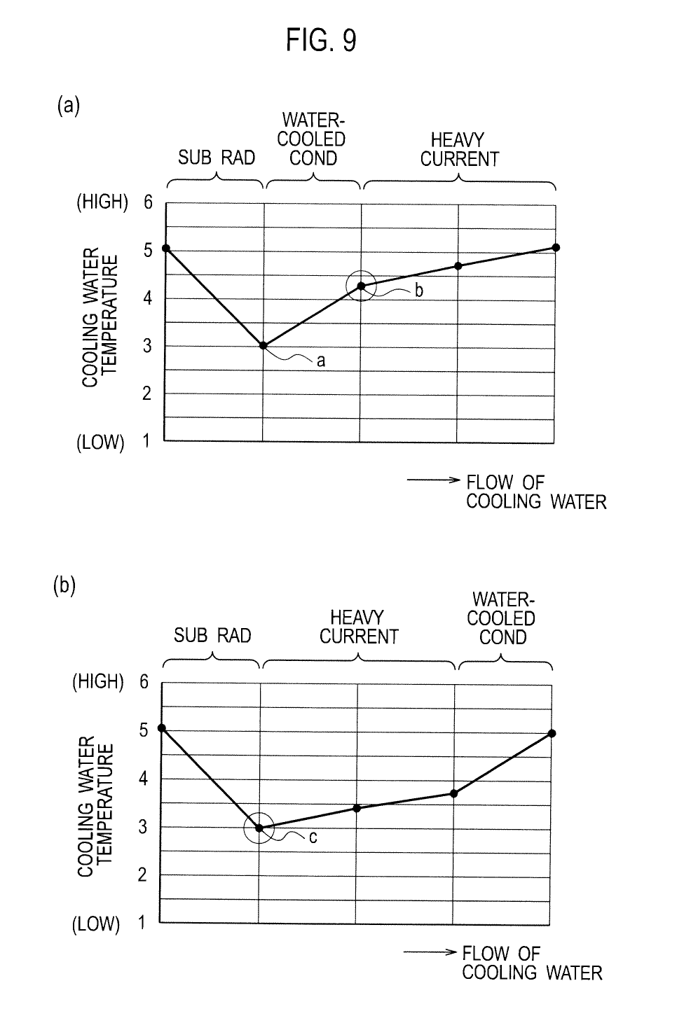

FIG. 9(a) is a graph illustrating a temperature situation of the water-cooling cooling water of the complex heat exchanger 100 according to the comparative example, and FIG. 9(b) is a graph illustrating the temperature situation of the water-cooling cooling water of the complex heat exchanger 1 according to this embodiment. Regarding cooling water temperatures in the graphs of FIGS. 9(a) and 9(b), values simply as rough estimates are illustrated and they are naturally different from actual temperatures.

Here, when the complex heat exchanger 100 according to the comparative example is compared with the complex heat exchanger 1 according to this embodiment, the flows of the water-cooling cooling water having passed through the water-cooled condensers are different. Specifically, in the complex heat exchanger 100 according to the comparative example, the water-cooled condenser 110 is provided on the mere outflow-side tank of the sub radiator 120 (see FIG. 17). The water-cooling cooling water cooled by the sub radiator 120 passes through the water-cooled condenser 110 and then, flows into the heavy current device 140. On the other hand, the air-conditioning refrigerant from the compressor flows into the water-cooled condenser 110 and is subjected to heat exchange with the water-cooling cooling water and is cooled, and then, flows into the air-cooled condenser 130.

As illustrated in FIGS. 7(a) and 7(b), in the complex heat exchanger 100 according to the comparative example, the water-cooling cooling water passing through the sub radiator 120 flows in a direction different from that of the air-conditioning refrigerant passing through the air-cooled condenser 130. In this case, the water-cooling cooling water cooled by the sub radiator 120 is close to the air-conditioning refrigerant before being cooled by the air-cooled condenser 130 and thus, the temperature can rise easily.

In addition, as illustrated in FIG. 9(a), a temperature of the water-cooling cooling water (water temperature “3” at a “a” point) cooled by the sub radiator 20 is raised when passing through the water-cooled condenser 110 by the air-conditioning refrigerant raised to a high temperature and a high pressure by the compressor 8. This water-cooling cooling water (water temperature “4.25” at a “b” point) with the raised temperature flows into the heavy current device 140.

On the other hand, as illustrated in FIGS. 8(a) and 8(b), in the complex heat exchanger 1, the water-cooling cooling water passing through the sub radiator 20 flows in the same direction as that of the air-conditioning refrigerant passing through the air-cooled condenser 40. In this case, the water-cooling cooling water cooled by the sub radiator 20 is separated from the air-conditioning refrigerant at a high temperature and a high pressure before being cooled by the air-cooled condenser 40 and thus, its temperature does not rise easily as compared with the comparative example.

In addition, as illustrated in FIG. 9(b), the water temperature (water temperature “3” at a “c” point) of the water-cooling cooling water cooled by the sub radiator 20 is lower than the water temperature (water temperature “4.25” at the “b” point in FIG. 9(a)) of the water-cooling cooling water immediately before flowing into the heavy current device 140 in the comparative example. Thus, the water-cooling cooling water cooled by the sub radiator 20 flows into the heavy current device 3 in a state with a water temperature lower than that of the water-cooling cooling water immediately before flowing into the heavy current device 140 in the comparative example. In this case, too, the air-conditioning refrigerant before being cooled by the air-cooled condenser 40 is cooled by passing through the water-cooled condenser 30.

### (Action/Effect)

In this embodiment described above, since the water-cooling cooling water cooled by the sub radiator 20 directly flows into the heavy current device 3, the heavy current device 3 can be efficiently cooled. Moreover, the air-conditioning refrigerant can be also cooled by the water-cooling cooling water before flowing into the air-cooled condenser 40. As described above, the heavy current device 3 can be efficiently cooled while the air-conditioning refrigerant before flowing into the air-cooled condenser 40 is cooled.

In this embodiment, since the water-cooling cooling water passing through the sub radiator 20 flows in the same direction as that of the air-conditioning refrigerant passing through the air-cooled condenser 40, heat influences of the water-cooling cooling water and the air-conditioning refrigerant on each other can be made as small as possible, and the heavy current device 3 can be efficiently cooled.

In this embodiment, since the width of the main radiator 10 is substantially equal to the widths of the sub radiator 20 and the air-cooled condenser 40 and since the water-cooled condenser 30 is provided in the inflow-side tank 23 of the sub radiator 20, its layout performance is excellent.

In this embodiment, the inflow-side tank 23 of the sub radiator 20 and the inflow/outflow tank 42 of the air-cooled condenser 40 are arranged close to the inflow-side tank 12 side of the main radiator 10, and the outflow-side tank 22 of the sub radiator 20 and the liquid-side tank 43 of the air-cooled condenser 40 are arranged close to the outflow-side tank 13 side of the main radiator 10. As a result, the heat influences of the cooling water for an engine, the water-cooling cooling water, and the air-conditioning refrigerant on each other can be made as small as possible, and heat exchange efficiency of the sub radiator 20 can be further increased.

Particularly, the inflow portion 23in in the inflow-side tank 23 of the sub radiator 20, the inflow portion 42A in the inflow/outflow tank 42 of the air-cooled condenser 40, and the inflow portion 12A, not shown, in the inflow-side tank 12, not shown, of the main radiator 10 are arranged on the same side with respect to a core portion (center portion) of the main radiator 10. In a state in which the main radiator 10, the sub radiator 20, and the air-cooled condenser 40 are assembled, the inflow portion 23in, the inflow portion 42A, and the inflow portion 12A are arranged on the same side surface side of the complex heat exchanger 1. As a result, the heat influences of the cooling water for an engine, the water-cooling cooling water, and the air-conditioning refrigerant on each other can be made as small as possible, and the heat exchange efficiency of the main radiator 10, the sub radiator 20, and the air-cooled condenser 40 can be further increased.

In this embodiment, the fixing claws 23f and 22f are formed on the inflow-side tank 23 and the outflow-side tank 22, the fixing claws 42f and 43f are formed on the inflow/outflow tank 42 and the liquid-side tank 43, and fixed portions 12a and 13a to which they are fixed are provided on the inflow-side tank 12 and the outflow-side tank 13 of the main radiator 10, respectively. As a result, only by inserting the fixing claws 23f, 22f, 42f, and 43f into the fixed portions 12a and 13a, an assembly 70 (the sub radiator 20, the water-cooled condenser 30, and the air-cooled condenser 40) can be easily assembled to the main radiator 10, and its layout performance is also improved.

### Second Embodiment

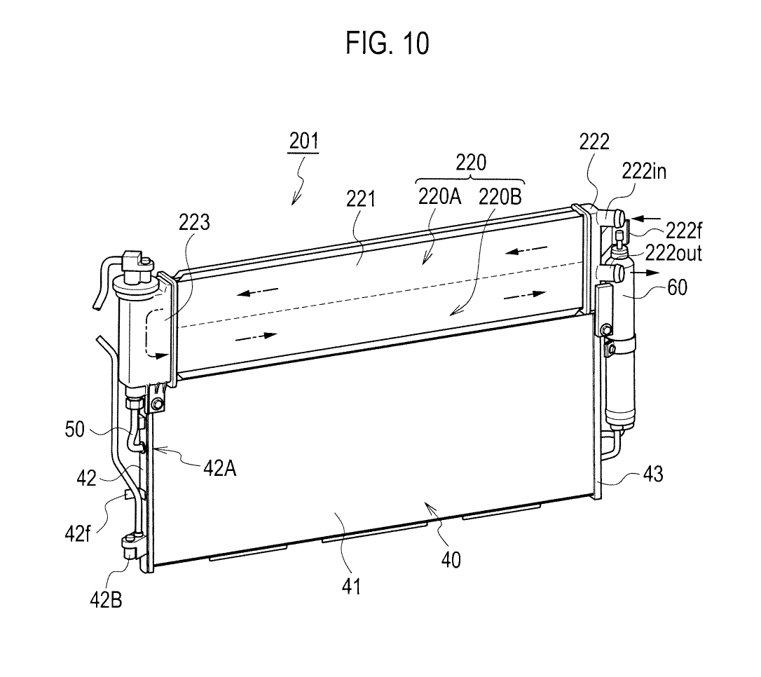

A complex heat exchanger 201 according to a second embodiment will be described by using FIGS. 10 to 15. A configuration of the complex heat exchanger 201 other than a sub radiator 220, a sub radiator tank (hereinafter referred to as an inflow/outflow tank 222 (first right-side tank) and a U-turn tank 223 (first left-side tank)) is similar to the configuration of the first embodiment. Same reference numerals are given in the figure to same configuration portions in the first embodiment, and explanation will be omitted, while only different configurations will be described.

### (Configuration of Complex Heat Exchanger)

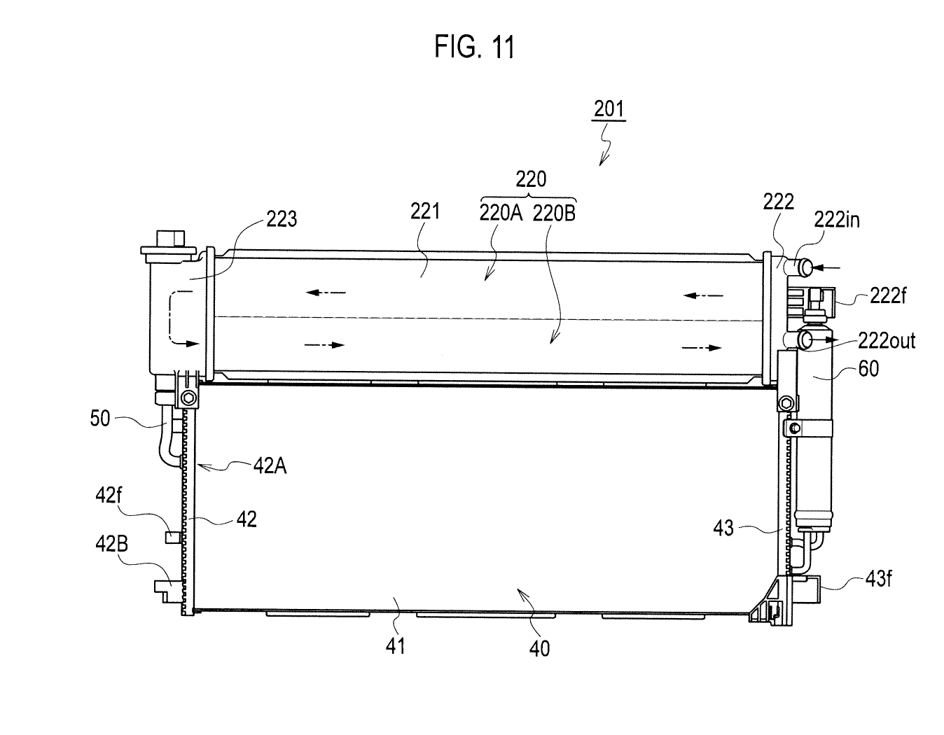

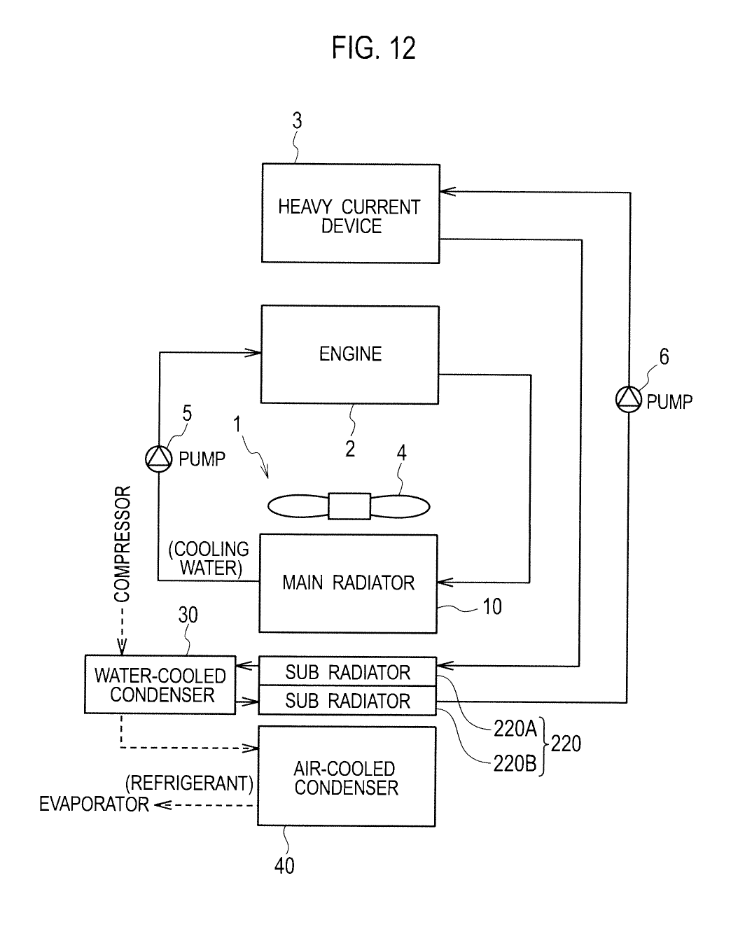

First, the configuration of the complex heat exchanger 201 according to this embodiment will be described by referring to the attached drawings. FIG. 10 is an entire perspective view illustrating the complex heat exchanger 201 according to this embodiment. FIG. 11 is a front view illustrating the complex heat exchanger 201 according to this embodiment. FIG. 12 is a configuration view illustrating a heat exchange system to which the complex heat exchanger 201 according to this embodiment is applied.

The sub radiator 220 is arranged on the upstream surface side of the cooling air of the main radiator 10 and on an upper region as illustrated in FIGS. 10 to 12. The sub radiator 220 includes a first heat exchange portion 220A and a second heat exchange portion 220B. Moreover, it includes a plurality of sub radiator tubes 221 through which the water-cooling cooling water passes and performing heat exchange with the cooling air flowing outside thereof and a sub radiator tank (hereinafter referred to as an inflow/outflow tank 222 (first right-side tank) and a U-turn tank 223) to which both ends of the plurality of sub radiator tubes 221 are connected, respectively.

The inflow/outflow tank 222 is provided on one side of the sub radiator 20 and on a side where the water-cooling cooling water flows in and out, while the U-turn tank 223 is provided on the other side of the sub radiator 20.

The first heat exchange portion 220A constitutes an upper region in the plurality of sub radiator tubes 221. As illustrated in FIG. 11, the water-cooling cooling water passing through the first heat exchange portion 220A flows from the inflow/outflow tank 222 toward the U-turn tank 223 (first left-side tank). The water-cooling cooling water cooled by this first heat exchange portion 220A is subjected to heat exchange with the water-cooled condenser 30 in the U-turn tank 223.

The second heat exchange portion 220B is provided on a lower side of the first heat exchange portion 220A and constitutes a lower region in the plurality of sub radiator tubes 221. As illustrated in FIG. 11, the water-cooling cooling water passing through the second heat exchange portion 220B flows from the U-turn tank 223 toward the inflow/outflow tank 222. The water-cooling cooling water cooled by this second heat exchange portion 220B is used for cooling the heavy current device 3.

In a state in which the sub radiator 220 is arranged with respect to the main radiator 10, the U-turn tank 223 of the sub radiator 220 and the inflow/outflow tank 42 of the air-cooled condenser 40 are arranged close to the inflow-side tank 12 side of the main radiator 10. Moreover, the inflow/outflow tank 222 of the sub radiator 220 and the liquid-side tank 43 of the air-cooled condenser 40 are arranged close to the outflow-side tank 13 side of the main radiator 10.

On each of the inflow/outflow tank 222 and the U-turn tank 223, fixing claws 222f and 223f each having a substantially L-shape are provided as fixing portions. The inflow/outflow tank 222 is provided on a side where the water-cooling cooling water flows in and out, and an inflow portion 222in into which the water-cooling cooling water flows and an outflow portion 222out from which the water-cooling cooling water flows are formed.

The U-turn tank 223 allows the water-cooling cooling water flowing out of the first heat exchange portion 220A to flow into the second heat exchange portion 220B. Unlike the inflow-side tank 23 in the first embodiment, the inflow portion 23in (refrigerant inlet) through which the water-cooling cooling water flows in is not formed in the U-turn tank 223. The other configurations are the same as those of the inflow-side tank 23 in the first embodiment.

### (Configuration of Water-Cooled Condenser)

A method of assembling the water-cooled condenser 30 to the U-turn tank 223 of the sub radiator 220 is the same as the method of assembling the water-cooled condenser 30 to the inflow-side tank 23 of the sub radiator 20 in the first embodiment. The water-cooled condenser 30 is accommodated in the U-turn tank 223.

### (Flow of Refrigerant)

A flow of the refrigerant in the above-described complex heat exchanger 201 will be described by referring to FIG. 12. The water-cooling cooling water for cooling the heavy current device 3 is cooled by the sub radiator 220.

Specifically, the water-cooling cooling water for cooling the heavy current device 3 circulates the first heat exchange portion 220A of the sub radiator 220, the water-cooled condenser 30, and the second heat exchange portion 220B of the sub radiator 220 in order and flows toward the heavy current device 3. That is, the water-cooling cooling water cooled by the first heat exchange portion 220A is subjected to heat exchange with the air-conditioning refrigerant in the water-cooled condenser 30. The water-cooling cooling water subjected to heat exchange in the water-cooled condenser 30 is then, subjected to heat exchange in the second heat exchange portion 220B. The water-cooling cooling water subjected to heat exchange by the second heat exchange portion 220B is then, used for cooling the heavy current device 3 as on-board device. The others are the same as the flow of the refrigerant in the first embodiment.

### (Comparative Evaluation)

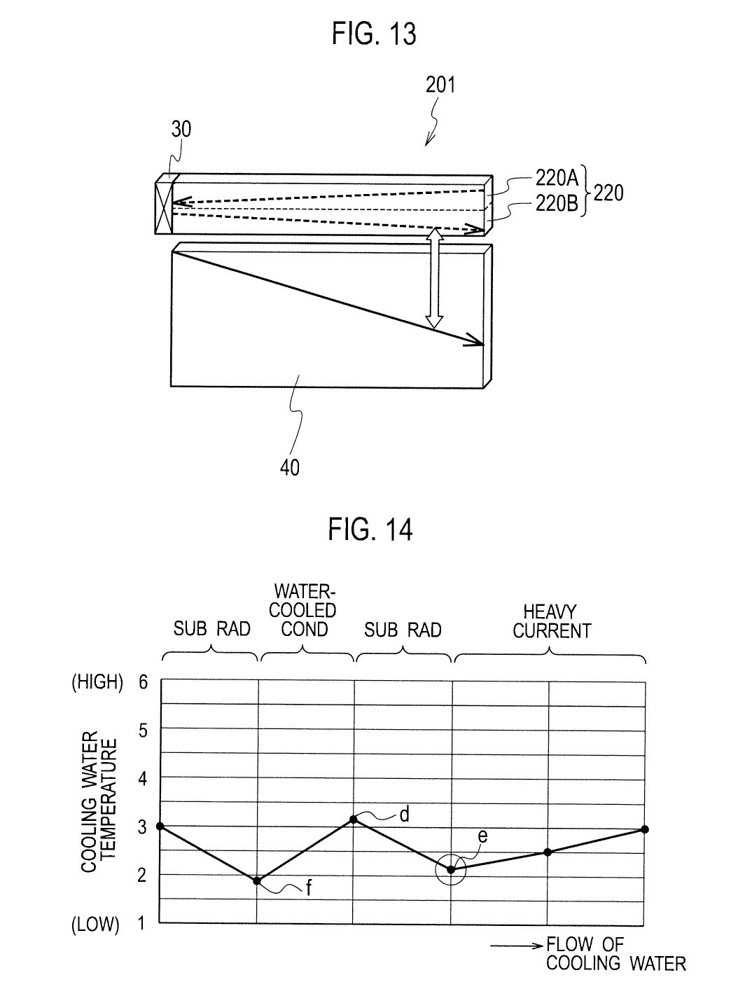

Subsequently, a comparative evaluation between the complex heat exchanger 100 as the comparative example illustrated in FIG. 17 and the complex heat exchanger 201 of this embodiment described above will be illustrated. The comparative evaluation will be described by referring to FIGS. 13 and 14.

FIG. 13 is a schematic view illustrating flows of the water-cooling cooling water and the air-conditioning refrigerant of the complex heat exchanger 201 according to this embodiment. FIG. 14 is a graph illustrating a temperature situation of the water-cooling cooling water of the complex heat exchanger 201 according to this embodiment. Regarding the cooling water temperature in the graph of FIG. 14, values simply as rough estimates are illustrated and they are naturally different from actual temperatures.

In the description of the first embodiment, as described by using FIGS. 7(a), 7(b), and 9(a), in the complex heat exchanger 100 according to the comparative example, the water-cooling cooling water passing through the sub radiator flows in a direction different from that of the air-conditioning refrigerant passing through the air-cooled condenser 40. In the comparative example, the temperature of the water-cooling cooling water cooled by the sub radiator 120 can rise easily.

On the other hand, as illustrated in FIG. 13, in the complex heat exchanger 201, the water-cooling cooling water passing through the second heat exchange portion 220B arranged on the upper side of the air-cooled condenser 40 flows in the same direction as that of the air-conditioning refrigerant passing through the air-cooled condenser 40. In this case, the water-cooling cooling water cooled by the second heat exchange portion 220B is spaced away from the air-conditioning refrigerant at a high temperature and a high pressure before being cooled by the air-cooled condenser 40 and thus, its temperature does not rise easily as compared with the comparative example.

In addition, as illustrated in FIG. 14, the temperature of the water-cooling cooling water cooled by the first heat exchange portion 220A rises by passing through the water-cooled condenser 30. That is, a water temperature “1.75” at an “f” point in FIG. 14 rises to a water temperature “3.25” at a “d” point in FIG. 14. This water-cooling cooling water whose temperature has risen is cooled by the second heat exchange portion 220B to a water temperature “2.25” at an “e” point in FIG. 14. The water temperature of this cooled water-cooling cooling water (water temperature “2.25” at the “e” point) is low as compared with the water temperature (water temperature “4.25” at the “b” point in FIG. 9(a)) of the water-cooling cooling water immediately before flowing into the heavy current device 140 in the comparative example. Thus, the water-cooling cooling water cooled by the second heat exchange portion 220B of the sub radiator 220 flows into the heavy current device 3 at a water temperature lower than that of the water-cooling cooling water immediately before flowing into the heavy current device 140 in the comparative example. Even in this case, the air-conditioning refrigerant before being cooled by the air-cooled condenser 40 can be cooled by passing through the water-cooled condenser 30.

### (Action/Effect)

In this embodiment described above, since the water-cooling cooling water cooled by the second heat exchange portion 220B of the sub radiator 220 directly flows into the heavy current device 3, the heavy current device 3 can be efficiently cooled. Moreover, the air-conditioning refrigerant can be also cooled by the water-cooling cooling water cooled by the first heat exchange portion 220A of the sub radiator 220. As a result, the heavy current device 3 can be efficiently cooled while the air-conditioning refrigerant before flowing into the air-cooled condenser 40 is cooled.

In this embodiment, since the first heat exchange portion 220A is provided on the upper side of the second heat exchange portion 220B (that is, provided on the one sub radiator 220), its layout performance is more excellent than a case in which each of the first heat exchange portion 220A and the second heat exchange portion 220B is an independent and individual sub radiator.

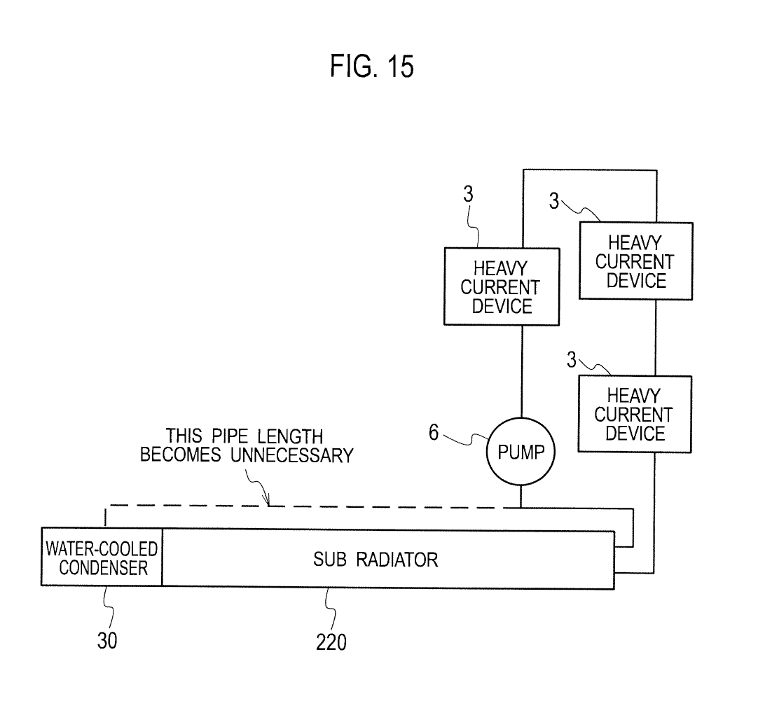

Particularly, since the inflow portion 222in and the outflow portion 222out are formed in the inflow/outflow tank 222, the heavy current device 3 (an electric driving source and other electric devices such as an inverter, for example) and the pump 6 can be disposed on the inflow/outflow tank 222 side as illustrated in FIG. 15. If the outflow portion is to be provided on the tank on a side where the water-cooled condenser 30 is provided, a pipe for returning the cooling water flowing out of this outflow portion to a pump side (a dotted portion in FIG. 15) becomes necessary. However, in this embodiment, since the inflow portion 222in and the outflow portion 222out are formed on the inflow/outflow tank 222, the pipe (the dotted portion in FIG. 15) is not necessary.

In this embodiment, since the water-cooling cooling water passing through the second heat exchange portion 220B arranged on the upper side of the air-cooled condenser 40 flows in the same direction as that of the air-conditioning refrigerant passing through the air-cooled condenser 40, heat influences of the water-cooling cooling water and the air-conditioning refrigerant on each other can be made as small as possible, and the heavy current device 3 can be cooled more efficiently.

In this embodiment, since the width of the main radiator 10 is substantially equal to the widths of the sub radiator 220 and the air-cooled condenser 40, and since the water-cooled condenser 30 is provided in the U-turn tank 223 of the sub radiator 220, its layout performances are excellent.

In this embodiment, the U-turn tank 223 of the sub radiator 20 and the inflow/outflow tank 42 of the air-cooled condenser 40 are arranged close to the inflow-side tank 12 of the main radiator 10, and the inflow/outflow tank 222 of the sub radiator 220 and the liquid-side tank 43 of the air-cooled condenser 40 are arranged close to the outflow-side tank 13 of the main radiator 10. As a result, heat influences of the cooling water for an engine and the water-cooling cooling water as well as the air-conditioning refrigerant on each other can be made as small as possible, and the heat exchange efficiency of the sub radiator 220 can be further increased.

Particularly, the inflow portion 222in in the inflow/outflow tank 222 of the sub radiator 220, the inflow portion 42A in the inflow/outflow tank 42 of the air-cooled condenser 40, and the inflow portion 12A, not shown, in the inflow-side tank 12, not shown, of the main radiator 10 are arranged on the same side as the core portion (center portion) of the main radiator 10. In a state in which the main radiator 10, the sub radiator 220, and the air-cooled condenser 40 are assembled, the inflow portion 222in, the inflow portion 42A, and the inflow portion 12A are arranged on the same side surface side as the complex heat exchanger 1. As a result, heat influences of the cooling water for an engine and the water-cooling cooling water as well as the air-conditioning refrigerant on each other can be made as small as possible, and the heat exchange efficiency of the main radiator 10, the sub radiator 220, and the air-cooled condenser 40 can be further increased.

In this embodiment, too, only by inserting the fixing claws 222f, 223f, 42f, and 43f in the fixed portions 12a and 13a similarly to the first embodiment, the assembly 70 (the sub radiator 220, the water-cooled condenser 30, and the air-cooled condenser 40) can be easily assembled to the main radiator 10, and its layout performance is improved.

### (Variation of Second Embodiment)

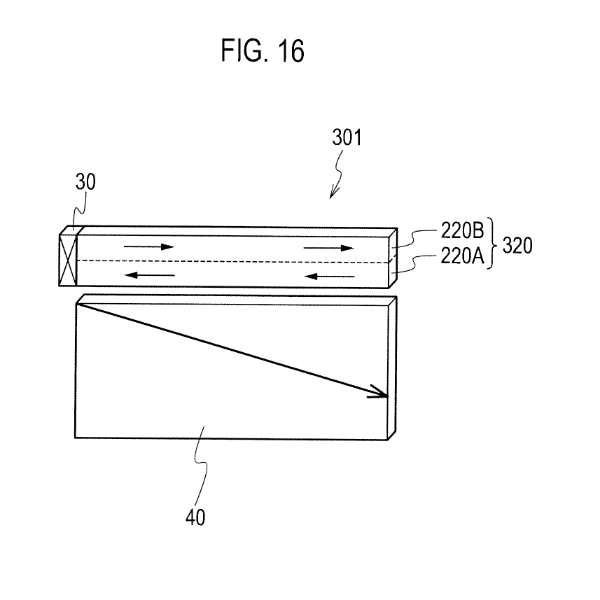

Subsequently, a variation of the complex heat exchanger according to the above-described embodiment will be described by referring to the attached drawings. FIG. 16 is a schematic view illustrating flows of the water-cooling cooling water and the air-conditioning refrigerant of the complex heat exchanger 301 according to the variation. The same reference numerals are given to the same portions as those in the complex heat exchanger 201 according to the above-described embodiment, and different portions will be mainly described.

In the above-described embodiment, the air-cooled condenser 40 is arranged adjacently on the lower side of the second heat exchange portion 220B, and the water-cooling cooling water passing through the second heat exchange portion 220B flows in the same direction as that of the air-conditioning refrigerant passing through the air-cooled condenser 40.

On the other hand, in the variation, as illustrated in FIG. 16, in a sub radiator 320, the second heat exchange portion 220B is arranged adjacently on the upper side of the first heat exchange portion 220A. The air-cooled condenser 40 is arranged adjacently on the lower side of the first heat exchange portion 220A. That is, the second heat exchange portion 220B is arranged at a position away from the air-cooled condenser 40 by sandwiching the first heat exchange portion 220A. Even in this case, the water-cooling cooling water passing through the second heat exchange portion 220B flows in the same direction as that of the air-conditioning refrigerant passing through the air-cooled condenser 40.

In such variation, since the water-cooling cooling water cooled by the second heat exchange portion 220B flows at a position away from the air-cooled condenser 40 (air-conditioning refrigerant at a high temperature and a high pressure), heat influences of the water-cooling cooling water and the air-conditioning refrigerant on each other can be made as small as possible, and the heat exchange efficiency of the second heat exchange portion 220B can be further increased.

### OTHER EMBODIMENTS

The embodiments of the present inventions are described as above, but these embodiments are mere exemplification described for facilitating understanding of the present invention, and the present invention cannot be limited to the embodiments. A technical scope of the present invention is not limited to the specific technical matters disclosed in the above-described embodiments but includes various variations, changes and alternative technologies that can be easily derived thereof. From this disclosure, various alternative embodiments, examples and application technologies are made obvious for those skilled in the art.

For example, the embodiments of the present invention can be changed as follows. Specifically, the complex heat exchangers 1, 201, and 301 are described as those used in a hybrid electric vehicle (HEV) on which the electric driving source or other electric devices including the heavy current device such as an inverter or the like is mounted other than the engine, but this is not limiting, and it may be other vehicles (an electric vehicle (EV, for example).

Moreover, the sub radiators 20, 220, and 320 and the air-cooled condenser 40 are described to be arranged on substantially the same plane along the direction orthogonal to the flow of the cooling air, but this is not limiting, and they may be arranged at positions slightly shifted.

Moreover, the sub radiators 20, 220, and 320 are described to be arranged on the upper side of the air-cooled condenser 40, but this is not limiting, and the air-cooled condenser 40 may be arranged on the upper sides of the sub radiators 20, 220, and 320.

Moreover, the first heat exchange portion 220A is described to be provided on the upper side or the lower side (upper side in the embodiments and the lower side in the variation) of the second heat exchange portion 220B, but this is not limiting, and they may be separate bodies. That is, the first heat exchange portion 220A and the second heat exchange portion 220B may be individual sub radiators each provided with a tube and a pair of tanks.

Moreover, the first heat exchange portion 220A and the second heat exchange portion 220B are described to be provided one each, but this is not limiting, and they may be alternately provided in plural (that is, two paths or more (plural turns).

Moreover, the water-cooling cooling water passing through the sub radiator 20 and the second heat exchange portion 220B is described to flow in the same direction as that of the air-conditioning refrigerant passing through the air-cooled condenser 40, but this is not limiting and it may flow in a direction different from that of the air-conditioning refrigerant passing through the air-cooled condenser 40.

Moreover, the third heat exchanger is described to be the water-cooled condenser 30, but this is not limiting, and it may be a water-cooled condenser or an oil cooler other than the embodiments. That is, the water-cooled condenser 30 described in the above-described embodiment is naturally only an example, and the water-cooled tube 31 does not necessarily have to be formed by extrusion molding, for example, and it may be an inner fin tube, a tube having a refrigerant passage or a tube body.

Moreover, the water-cooled condenser 30 is described to be accommodated in the inflow-side tank 23 of the sub radiator 20 or the U-turn tank 223 of the sub radiators 220 and 320, but this is not limiting. It may be mounted on a periphery of the inflow-side tank 23 of the sub radiator 20 or in the periphery of the U-turn tank 223 of the sub radiators 220 and 320, for example.

As described above, it is natural that the present invention includes various embodiments not described here. Therefore, a technical scope of the present invention is determined by invention specifying matters according to claims appropriate from the above-described explanation.

The present application claims for priority based on Japanese Patent Application No. 2013-043894 filed on Mar. 6, 2013 and priority based on Japanese Patent Application No. 2013-043895 filed on Mar. 6, 2013, and the whole contents of the two applications are incorporated in this Description by reference.

### INDUSTRIAL APPLICABILITY

According to features of the present invention, since the first refrigerant cooled by the first heat exchanger directly flows to the heavy current device, the heavy current device can be efficiently cooled. Moreover, the second refrigerant can be also cooled by the first refrigerant before flowing into the first heat exchanger. As a result, the heavy current device can be efficiently cooled while the air-conditioning refrigerant before flowing into the air-cooled condenser is cooled.

### REFERENCE SIGNS LIST

1, 201, 301 complex heat exchanger
3 heavy current device (on-board device)
10 main radiator (fourth heat exchanger)
12 inflow-side tank (fourth inflow-side tank)
12A inflow portion
13 outflow-side tank (fourth outflow-side tank)
12a, 13a fixed portion
20, 220 sub radiator (first heat exchanger)
21,221 sub radiator tube
22 outflow-side tank (first right-side tank)
23 inflow-side tank (first left-side tank)
23in, 222in inflow portion (refrigerant inlet)
22out, 222out outflow portion (refrigerant outlet)
22f, 23f, 222f, 223f fixing claw (fixing portion)
30 water-cooled condenser (third heat exchanger)
40 air-cooled condenser (second heat exchanger)
42 inflow/outflow tank (second inflow/outflow tank)
42A inflow portion (refrigerant inlet)
43 liquid-side tank (tank for second turn)
42f, 43f fixing claw (fixing portion)
50 relay pipeline
60 liquid tank
70 assembly
220A first heat exchange portion
220B second heat exchange portion
222 inflow/outflow tank (first right-side tank)
223 U-turn tank (first left-side tank)

1. A complex heat exchanger, comprising:
a first heat exchanger for cooling a first refrigerant;
a second heat exchanger for cooling a second refrigerant different from the first refrigerant; and
a third heat exchanger for performing heat exchange between the first refrigerant and the second refrigerant, wherein
the first refrigerant performs heat exchange with the second refrigerant when passing through the third heat exchanger;
the first refrigerant subjected to heat exchange in the third heat exchanger is cooled when passing through the first heat exchanger;
the first refrigerant cooled by the first heat exchanger is used for cooling heavy current device; and
the second refrigerant subjected to heat exchange in the third heat exchanger passes through the second heat exchanger.

2. The complex heat exchanger according to claim 1, wherein
the second heat exchanger is arranged on an upper side or a lower side of the first heat exchanger; and
the first refrigerant passing through the first heat exchanger flows in the same direction as the second refrigerant passing through the second heat exchanger.

3. The complex heat exchanger according to claim 1, wherein
the first heat exchanger has:
a first heat exchange portion; and
a second heat exchange portion provided on an upper side or a lower side of the first heat exchange portion, and
the first refrigerant passes through the second heat exchange portion via the third heat exchanger after passing through the first heat exchange portion.

4. The complex heat exchanger according to claim 3, wherein
the second heat exchanger is arranged adjacent to the second heat exchange portion; and
the first refrigerant passing through the second heat exchange portion flows in the same direction as the second refrigerant passing through the second heat exchanger.

5. The complex heat exchanger according to claim 3, wherein
the second heat exchange portion is arranged adjacent to the first heat exchange portion; and
the second heat exchange portion is arranged at a position away from the second heat exchanger by sandwiching the first heat exchange portion.

6. The complex heat exchanger according to claim 1, wherein
the first heat exchanger includes:
a first right-side tank provided on one side of the first heat exchanger and on a side where the first refrigerant flows out; and
a first left-side tank provided on the other side of the first heat exchanger.

7. The complex heat exchanger according to claim 6, wherein
the third heat exchanger is provided in the first left-side tank.

8. The complex heat exchanger according to claim 6, further comprising:
a fourth heat exchanger provided on a downstream side of a cooling air passing through the first heat exchanger and the second heat exchanger, wherein
to a fourth inflow-side tank of the fourth heat exchanger, the first left-side tank and a second inflow/outflow tank of the second heat exchanger are fixed close to each other; and
to a fourth outflow-side tank of the fourth heat exchanger, the first right-side tank and a tank for a second turn of the second heat exchanger are fixed close to each other.

9. The complex heat exchanger according to claim 1, further comprising:
a fourth heat exchanger provided on a downstream side of a cooling air passing through the first heat exchanger and the second heat exchanger.

10. The complex heat exchanger according to claim 8, wherein
the first heat exchanger and the second heat exchanger have fixing portions, respectively; and
the fourth heat exchanger has a fixed portion to which the fixing portions are fixed, respectively.

11. The complex heat exchanger according to claim 8, wherein
a refrigerant inlet of the first heat exchanger;
a refrigerant inlet of the second heat exchanger; and
a refrigerant inlet of the fourth heat exchanger are arranged on the same side with respect to a core portion of the fourth heat exchanger.
